(19) United States
(12) Patent Application Publication
(10) Pub. No.: US 2025/0313775 A1
(43) Pub. Date: Oct. 9, 2025

(54) METHOD OF REMOVING SULFUR-CONTAINING DEPOSITS FROM LANDFILL INFRASTRUCTURE

(71) Applicant: Kroff Landfill Technologies, Inc., Pittsburgh, PA (US)

(72) Inventors: David Earl Schwab, Renfrew, PA (US); Jacob Nicholas Very, Pittsburgh, PA (US)

(21) Appl. No.: 19/172,442

(22) Filed: Apr. 7, 2025

Related U.S. Application Data
(60) Provisional application No. 63/631,496, filed on Apr. 9, 2024.

(51) Int. Cl. C11D 1/83; B08B 9/027; C11D 1/00; C11D 1/72; C11D 3/04; E02D 31/00

(52) U.S. Cl. CPC C11D 1/83; B08B 9/027; C11D 3/044; B08B 2209/027; C11D 1/008; C11D 1/72; E02D 31/00

(57) ABSTRACT

The present disclosure is directed to a method of removing a sulfur-containing deposit from landfill infrastructure comprising: (a) forming a treatment composition comprising an alkaline material; and (b) contacting the sulfur-containing deposit within the landfill infrastructure with the treatment composition, whereby the sulfur-containing deposit is at least partially dissolved.

### CROSS-REFERENCE TO RELATED APPLICATION

This application claims the benefit of U.S. Provisional Patent Application No. 63/631,496 filed Apr. 9, 2024, which is incorporated herein by reference.

### FIELD

The present disclosure relates to a method for removing a sulfur-containing deposit from landfill infrastructure.

### BACKGROUND

Landfills, such as used for the collection of municipal solid waste, typically generate landfill gas, which includes methane. The landfill gas typically results from the bacterial decomposition of waste within the landfill under anaerobic conditions. Landfill gas typically includes about 50 to 55 percent methane, 45 to 50 percent carbon dioxide, less than 1 percent of non-methane organic compounds, and trace amounts of inorganic compounds. The methane and carbon dioxide of landfill gas are greenhouse gasses, with methane being a more potent greenhouse gas than carbon dioxide. As such, the collection of landfill gas is desirable at least for reasons of limiting the amount of greenhouse gasses emitted from a landfill directly into the atmosphere. The methane of the collected landfill gas can be flared or further isolated and used as a fuel, such as for electric power generation. A landfill gas collection system typically includes a landfill gas extraction pipe including a perforated section that extends beneath the surface of the landfill, and up through which landfill gas passes and is collected and removed at the wellhead thereof, which resides above the surface of the landfill.

Landfills, such as used for the collection of municipal solid waste, typically have associated therewith landfill leachate. Landfill leachate is a liquid that results from water percolating through the landfill. If landfill leachate escapes from the landfill, it can contaminate ground water, including wells, and/or surface water, including lentic and/or lotic waters. Landfill leachate is typically collected and removed from the landfill by a landfill leachate collection system. The collected landfill leachate is typically subjected to treatment prior to further use and/or disposal thereof. A landfill leachate collection system typically includes a landfill leachate pipe having a perforated section that extends beneath the surface of the landfill, and up through which landfill leachate is drawn, and collected and removed at the head thereof. The landfill leachate pipe may run along the bottom floor of the landfill and may be covered by gravel packing.

The landfill infrastructure, including the landfill gas extraction system and landfill leachate collection system, can become occluded with a sulfur-containing deposit. Occlusion of the landfill gas extraction pipe can minimize or prevent the passage of landfill gas up through the pipe, impede gas flow and/or extraction, and result in the emission of extraneous landfill gas directly into the atmosphere. Occlusion of the landfill leachate pipe can minimize or prevent the passage of landfill leachate up through the landfill leachate pipe, and result in leachate escaping from the landfill and contaminating ground water and/or surface water.

The sulfur-containing deposit can be difficult to remove, such as from the interior of a landfill gas extraction pipe and system and/or landfill leachate pipe and system. In some instances, typical pipe cleaning methods, such as pigging, pipeline snakes, and high-pressure fluid jet cleaners, are not easily applicable for purposes of removing the sulfur-containing deposit for reasons including the amount of time and energy involved and the durability of the sulfur-containing deposit.

It would be desirable to develop new methods for removing sulfur-containing deposits from landfill infrastructure, such as from the interior of landfill gas extraction pipes and/or landfill leachate collection pipes.

### SUMMARY

The present disclosure is directed to a method of removing a sulfur-containing deposit from landfill infrastructure comprising: (a) forming a treatment composition comprising an alkaline material; and (b) contacting the sulfur-containing deposit within the landfill infrastructure with the treatment composition, whereby the sulfur-containing deposit is at least partially dissolved.

### DETAILED DESCRIPTION

As used herein, the term “polymer” means homopolymers (e.g., prepared from a single monomer species), copolymers (e.g., prepared from at least two monomer species), and graft polymers.

As used herein, the term “(meth)acrylate” and similar terms, such as “(meth)acrylic acid ester” means methacrylates and/or acrylates. As used herein, the term “(meth)acrylic acid” means methacrylic acid and/or acrylic acid.

The present disclosure is directed to a method of removing a sulfur-containing deposit from landfill infrastructure comprising: (a) forming a treatment composition comprising an alkaline material; and (b) contacting the sulfur-containing deposit within the landfill infrastructure with the treatment composition, whereby the sulfur-containing deposit is at least partially dissolved.

The sulfur-containing deposit comprises elemental sulfur. As used herein, the term “elemental sulfur” refers to sulfur in a form that is not compounded with other non-sulfur elements (such as in the form of sulfates, sulfites, or sulfur dioxide). Elemental sulfur may include various allotropes of sulfur. The sulfur-containing deposit may comprise other forms of sulfur (e.g., sulfates, etc.) as well as other non-sulfur-containing elements and compounds in addition to elemental sulfur.

The treatment composition of the present disclosure comprises an alkaline material. As used herein, the term “alkaline material” refers to at least partially water-soluble basic compounds or complexes that increase the pH of a water-based solution when the alkaline material is added to and at least partially dissolved in water. The alkaline material may comprise complexes comprising hydroxide(s), as well as various forms of lime (CaO and/or Ca(OH)₂). The complexes comprising hydroxide may comprise alkali metal hydroxides or alkaline earth metal hydroxides such as sodium hydroxide, potassium hydroxide, calcium hydroxide, and magnesium hydroxide, ammonium hydroxide, or any combinations thereof.

The amount of alkaline material present in the treatment composition any suitable amount. For example, the alkaline material may be present in an amount such that the treatment composition has an alkaline pH. For example, the treatment composition may have a pH of at least 8, such as at least 8.5, such as at least 9, such as at least 9.5, such as at least 10, such as at least 10.5, such as at least 11, such as at least 11.5, such as at least 12, such as at least 12.5, such as at least 13, such as at least 13.5, such as 14. The alkaline material may be added to the treatment composition in an amount up to its solubility limit in water.

The treatment composition may optionally further comprise a surfactant. The surfactant may comprise a non-ionic surfactant.

Non-ionic surfactants are free of ionic groups, such as anionic groups and/or cationic groups. The non-ionic surfactant optionally may comprise one or more hydroxyl groups. The non-ionic surfactants may comprise polyalkylene oxides, which optionally include one or more hydroxyl groups. The non-ionic polyalkylene oxides comprise residues (or monomer units) selected from ethylene oxide, propylene oxide, butylene oxide, and combinations thereof. The non-ionic polyalkylene oxides may be block copolymer polyalkylene oxides including residues (or monomer units) selected from at least two of ethylene oxide, propylene oxide, and butylene oxide. The non-ionic polyalkylene oxides may comprise alkylphenol ethoxylates, such as nonylphenol ethoxylates, including nonoxynol-9. The nonylphenol ethoxylate may include 4 moles of ethylene oxide, 6 moles of ethylene oxide, 9 moles of ethylene oxide, 11 moles of ethylene oxide, or any combination thereof. Examples of suitable commercially available surfactants include TERGITOL™ NP-4 (nonylphenol ethoxylate having 4 moles of EO non-ionic surfactant), TERGITOL™ NP-9 (nonylphenol ethoxylate having 9 moles of EO non-ionic surfactant), TERGITOL™ NP-11 (nonylphenol ethoxylate having 11 moles of EO non-ionic surfactant), and TRITON™ DF-12 (modified polyethoxylated alcohol non-ionic surfactant), each available from The Dow Chemical Company.

The non-ionic surfactant may be present in the treatment composition in an amount of at least 0.01 parts by weight, such as at least 0.1 parts by weight, such as at least at least 1 part by weight, such as at least 2 parts by weight, per 100 parts by weight of the alkaline material. The non-ionic surfactant may be present in the treatment composition in an amount of no more than 10 parts by weight, such as no more than 5 parts by weight, such as no more than 3 parts by weight, per 100 parts by weight of the alkaline material. The non-ionic surfactant may be present in the treatment composition in an amount of 0.01 to 10 parts by weight, such as 0.01 to 5 parts by weight, such as 0.01 to 3 parts by weight, such as 0.1 to 10 parts by weight, such as 0.1 to 5 parts by weight, such as 0.1 to 3 parts by weight, such as 1 to 10 parts by weight, such as 1 to 5 parts by weight, such as 1 to 3 parts by weight, such as 2 to 10 parts by weight, such as 2 to 5 parts by weight, such as 2 to 3 parts by weight, per 100 parts by weight of the alkaline material.

The treatment composition may optionally further comprise a dispersant. The dispersant may comprise homopolymers, copolymers and terpolymers of maleic acid; homopolymers, copolymers and terpolymers of (meth)acrylic acid; homopolymers, copolymers and terpolymers of 2-acrylamido-2-methylpropane sulfonic acid; homopolymers, copolymers and terpolymers of sulfonated styrene; and phosphino-carboxylic acid polymers (PCA); as well as combinations thereof. A non-limiting example of the dispersant includes a copolymer of acrylic acid and 2-acrylamido-2-methylpropane sulfonic acid.

The dispersant may be present in the treatment composition in an amount of at least 0.05 parts by weight, such as at least 0.1 part by weight, such as at least 0.5 parts by weight, such as at least at least 1 parts by weight, per 100 parts by weight of the alkaline material. The dispersant may be present in the treatment composition in an amount of no more than 2.5 parts by weight, such as no more than 2 parts by weight, such as no more than 1.5 parts by weight, per 100 parts by weight of the alkaline material. The dispersant may be present in the treatment composition in an amount of 0.05 to 2.5 parts by weight, such as 0.05 to 2 parts by weight, such as 0.05 to 1.5 parts by weight, such as 0.1 to 2.5 parts by weight, such as 0.1 to 2 parts by weight, such as 0.1 to 1.5 parts by weight, such as 0.5 to 2.5 parts by weight, such as 0.5 to 2 parts by weight, such as 0.5 to 1.5 parts by weight, such as 1 to 2.5 parts by weight, such as 1 to 2 parts by weight, such as 1 to 1.5 parts by weight, per 100 parts by weight of the alkaline material. As used herein, parts by weight of the dispersant refers to the weight of the active dispersant and does not include any other components that may be added with a dispersant composition, such as water and/or other additives.

The treatment composition may comprise other optional additives. Classes of additives that can optionally be present in the treatment composition include but are not limited to: antifoam agents; corrosion inhibitors; biocides; peroxide catalysts; peroxide activators; pH modifiers (including acids, bases, and buffers); and combinations of two or more thereof. Peroxide catalysts include, but are not limited to, transition metal compounds, such as transition metal sulfates, such as ferrous sulfate and copper sulfate. Peroxide activators include, but are not limited to, alkanoylamines, such as tetraalkanoylalkylenediamine, such as tetraacetylethylenediamine.

The treatment composition optionally may be substantially free, essentially free, or completely free of ethylenediaminetetraacetic acid, nitrilotriacetic acid, diethylene-triamine pentaacetic acid, sodium sulfite, sodium bisulfite, potassium sulfite, potassium bisulfite, and/or hydroxyethylethylenediaminetriacetic acid. As used herein, “substantially free” with respect to any one of these materials means the material is present in the treatment composition in an amount of less than 5 parts by weight per 100 parts by weight of the alkaline material. As used herein, “essentially free” with respect to any one of these materials means the material is present in the treatment composition in an amount of less than 1 parts by weight per 100 parts by weight of the alkaline material. As used herein, a treatment composition is “completely free” of these materials if the individual material is not present in the treatment composition, i.e., 0.0 parts by weight per 100 parts by weight of the alkaline material.

The treatment composition may be formed by any appropriate method. For example, a composition comprising the alkaline material and optionally a surfactant and/or a dispersant may be added to an aqueous medium, such as a landfill leachate, in fluid communication with the sulfur-containing deposit or in which the sulfur-containing deposit resides. In such case, the treatment composition may be formed in situ with the sulfur-containing deposit.

The composition used to form the treatment composition may optionally further comprise water or other liquid carrier or alternatively may be free of water or other liquid carrier.

Contacting together the treatment composition and the sulfur-containing deposit may be conducted by any suitable method. For example, contacting together the treatment composition and the sulfur-containing deposit may be conducted by an application method comprising at least one of spray application of the treatment composition, static immersion application of the treatment composition, flow application of the treatment composition, or pressurized application of the treatment composition. With spray application, the treatment composition is sprayed onto and/or over the sulfur-containing deposit. Spray application methods include, but are not limited to, high pressure jet spray application. With static immersion application, the sulfur-containing deposit is immersed statically in the treatment composition. With flow application, the treatment composition is flowed over the sulfur-containing deposit.

With each of the application methods, the sulfur-containing deposit is free standing and/or associated with a surface of a substrate, such as abutting against and/or adhered to the surface of a substrate. The substrate is part of landfill infrastructure including, but not limited to, piping, sumps, screens, wellbore, the grit chamber, the force main, gravel packing, and/or solid waste material, as well as any other equipment and/or elements associated therewith. For example, the substrate includes, but is not limited to: a pipe, such as a landfill gas extraction pipe and/or a landfill leachate pipe; and/or a sump that is in fluid communication with a landfill gas extraction pipe and/or a landfill leachate pipe. The surface of the substrate with which the sulfur-containing deposit is associated may include: an interior surface of a pipe, such as the interior surface of a landfill gas extraction pipe and/or a landfill leachate pipe; and/or an interior surface of a sump that is in fluid communication with a landfill gas extraction pipe; and/or equipment and/or elements in and/or associated with a sump and/or pipe, such as, but not limited to, pumps, screens, the exterior surface of the pipe, the grit chamber, the force main of the leachate collection system, gravel packing, and/or waste material.

Contacting together the treatment composition and the sulfur-containing deposit is conducted under any suitable conditions. For example, contacting together the treatment composition and the sulfur-containing deposit may be conducted at a temperature of from ambient temperature to a temperature that is less than the boiling point of the treatment composition, such as from ambient temperature to 99° C., or from 10° C. to 99° C., or from 15° C. to 99° C., or from 20° C. to 99° C., or from 25° C. to 99° C. Contacting together the treatment composition and the sulfur-containing deposit may be conducted under ambient pressure or under the application of pressure, such as from 14.7 pounds per square inch (psi) to 20,000 psi (such as in the case of high pressure jet application methods), or from 14.7 psi to 1,000 psi. Added pressure may assist in forcing the treatment composition beyond the wellbore, gas extraction pipe, and/or landfill leachate collection system such that the treatment composition contacts sulfur-containing deposit present on the exterior surface of the pipe, the grit chamber, gravel packing, and/or waste material.

Contacting together the treatment composition and the sulfur-containing deposit results in the at least partial dissolution of the sulfur-containing deposit and formation of a modified treatment composition that includes at least a portion of the dissolved sulfur-containing deposit. The at least partial dissolution of the sulfur-containing deposit may further result in portions of the solid sulfur-containing deposit to be disassociated with the sulfur-containing deposit and suspended in the modified treatment composition. Accordingly, the modified treatment composition may comprise the sulfur-containing deposit in a form selected from at least partially dissolved sulfur-containing deposit, suspended sulfur-containing deposit, and combinations thereof.

The treatment composition and the modified treatment composition are each independently flowable.

The treatment composition may be contacted with the sulfur-containing deposit for any suitable period of time. For example, the treatment composition may be contacted with the sulfur-containing deposit for a residence period of at least 1 hour. The modified treatment composition may be formed during the residence period. For example, the residence time may be at least 30 minutes, such as at least 1 hour, such as at least 4 hours, such as at least 8 hours, such as at least 12 hours, such as at least 18 hours, such as at least 24 hours, such as at least 30 hours, such as at least 36 hours, such as at least 42 hours, such as at least 48 hours, such as at least 72 hours, or longer.

The method may further comprise removing the modified treatment composition.

The method may optionally further comprise reintroducing into the landfill infrastructure, such as the interior of a pipe, at least a portion of the removed modified treatment composition and optionally introducing an additional amount of the treatment composition.

The removed modified treatment composition may optionally be stored and/or subjected to further treatment such as, but not limited to: settling; filtering; precipitation; pH adjustment; dilution; microbial digestion; evaporation; sanitization; and combinations thereof.

The sulfur-containing deposit may reside within an interior of a landfill gas extraction pipe that extends beneath a surface of a landfill, and the method of the present disclosure further includes introducing the treatment composition into the interior of the landfill gas extraction pipe, wherein the treatment composition contacts the sulfur-containing deposit within the interior of the landfill gas extraction pipe.

The landfill gas extraction pipe may comprise a wellhead that resides above the surface of said landfill, and the method of the present disclosure may comprise introducing the treatment composition through the wellhead and into the interior of the landfill gas extraction pipe, wherein the treatment composition contacts the sulfur-containing deposit within the interior of the landfill gas extraction pipe.

The treatment composition may be introduced as a single dose, continuously, and/or intermittently into the landfill gas extraction pipe; and the modified treatment composition may be removed continuously and/or intermittently from the landfill gas extraction pipe. The treatment composition may be poured into and/or pumped into the landfill gas extraction pipe. The modified treatment composition may be pumped out of the landfill gas extraction pipe.

The method may further comprise removing the modified treatment composition from the interior of the landfill gas extraction pipe, and introducing into the interior of the landfill gas extraction pipe, (i) at least a portion of the modified treatment composition, or (ii) a combined treatment composition including a combination of the modified treatment composition and the treatment composition.

The landfill gas extraction pipe may have a lower end that is in fluid communication with a sump that resides beneath the surface of the landfill, and the sulfur-containing deposit may reside within the sump. Accordingly, the method may comprise introducing the treatment composition into the sump, wherein the treatment composition contacts the sulfur-containing deposit within the sump. A liquid, such as landfill leachate, may be collected within and removed from the sump, such as through a separate sump pipe. Collection of landfill leachate within and removal of landfill leachate from the sump minimizes or prevents landfill leachate from moving up through the landfill gas extraction pipe. The presence of landfill leachate within the landfill gas extraction pipe can interfere with the collection and removal of landfill gas from the landfill gas extraction pipe.

The sulfur-containing deposit may reside within an interior of a landfill leachate pipe that extends beneath a surface of a landfill, and the sulfur-containing deposit may be present in the landfill leachate pipe, and the method of the present disclosure may comprise introducing the treatment composition into the interior of the landfill leachate pipe, wherein the treatment composition contacts the sulfur-containing deposit within the interior of the landfill leachate pipe.

Contact of the treatment composition with the sulfur-containing deposit within the interior of the landfill leachate pipe results in formation of the modified treatment composition. The modified treatment composition may be removed from the landfill leachate pipe.

The landfill leachate pipe may comprise a head (or wellhead, cleanout, union, etc.) that resides above the surface of said landfill, and the method may further comprise introducing the treatment composition through the head/wellhead and into the interior of the landfill leachate pipe, wherein the treatment composition contacts the sulfur-containing deposit within the interior of the landfill leachate pipe.

The treatment composition may be introduced as a single dose, continuously, and/or intermittently into the landfill leachate pipe; and the modified treatment composition may be removed continuously and/or intermittently from the landfill leachate pipe. The treatment composition may be poured into and/or pumped into the landfill leachate pipe. Added pressure may assist in forcing the treatment composition beyond the wellbore such that the treatment composition contacts sulfur-containing deposit present on the exterior surface of the pipe, the gravel packing, and/or solid waste material, as well as any other sulfur-containing deposit nearby. As an alternative to or in addition to pressurization, a vacuum may be applied to the landfill leachate pipe in order to assist in movement of the treatment composition and/or modified treatment composition through the landfill leachate pipe. The modified treatment composition may be pumped out of the landfill leachate pipe. The modified treatment composition may be vacuum assisted out of the landfill leachate pipe.

The method may further comprise removing the modified treatment composition from the interior of the landfill leachate pipe, and introducing into the interior of the landfill leachate pipe, (i) at least a portion of the modified treatment composition, or (ii) a combined treatment composition including a combination of the modified treatment composition and the treatment composition.

The landfill leachate pipe may have a lower end that is in fluid communication with a sump that resides beneath the surface of the landfill, and the sulfur-containing deposit may be present in the sump. The method may further comprise introducing the treatment composition into the sump, wherein the treatment composition contacts the sulfur-containing deposit within the sump.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Example 1

An elemental sulfur-containing deposit was obtained from a landfill in Florida. Samples of the deposit were placed in landfill leachate. Various treatments were added to the leachate and sulfur-containing deposit to determine the efficacy of each treatment to dissolve the sulfur-containing deposit. Each sample had about 2 grams of the sulfur containing deposit and 10 grams of landfill leachate. The mass of each composition added to the samples to form the treatment composition was about 8 grams total. Following addition of the treatment, the samples were allowed to rest at room temperature for 24 hours. After 24 hours had elapsed, the solids remaining in each sample were collected by filtration, dried and their final mass determined. A summary of the results are shown in the table below.

TABLE 1

| | | | Mass of deposit |
|---|---|---|---|
| | | Percent | dissolved/mass of |
| | | deposit | active ingredient in |
| Sample | Treatment description | dissolved | treatment |
| 1a | 8 g of 50% NaOH | 48% | 0.24 |
| 1b | 8 g of 50% NaOH | 49% | 0.25 |
| 2a | 8 g of 50% NaOH with 0.1 g NP-9¹ | 60% | 0.29 |
| 2b | 8 g of 50% NaOH with 0.1 g NP-9¹ | 62% | 0.30 |
| 3a | 8 g of 50% NaOH with 1 g AA/AMPS copolymer | 53% | 0.21 |
| | solution² | | |
| 3b | 8 g of 50% NaOH with 1 g AA/AMPS copolymer | 53% | 0.21 |
| | solution² | | |
| 4a | 8 g of 50% NaOH with 0.1 g NP-9¹ and 1 g | 54% | 0.22 |
| | AA/AMPS copolymer solution² | | |
| 4b | 8 g of 50% NaOH with 0.1 g NP-9¹ and 1 g | 61% | 0.24 |
| | AA/AMPS copolymer solution² | | |
| 5a | 8 g 45% KOH | 53% | 0.29 |
| 5b | 8 g 45% KOH | 50% | 0.28 |
| 6a | 4 g 50% NaOH and 4 g 45% KOH | 60% | 0.32 |
| 6b | 4 g 50% NaOH and 4 g 45% KOH | 53% | 0.28 |
| 7a | 4 g 50% NaOH, 0.08 g Tomamine ® Alkali | 12% | 0.12 |
| | Surfactant³ and 3.92 g water | | |
| 7b | 4 g 50% NaOH, 0.08 g Tomamine ® Alkali | 12% | 0.11 |
| | Surfactant³ and 3.92 g water | | |
| 8a | 5.33 g 50% NaOH and 2.66 g 45% KOH | 41% | 0.22 |
| 8b | 5.33 g 50% NaOH and 2.66 g 45% KOH | 44% | 0.23 |
| 9a | 7.92 g 45% KOH and 0.08 Tomamine ® Alkali | 40% | 0.22 |
| | Surfactant³ | | |
| 9b | 7.92 g 45% KOH and 0.08 Tomamine ® Alkali | 37% | 0.21 |
| | Surfactant³ | | |
| 10a | 5.25 g 50% NaOH, 2.63 g 45% KOH and 0.1 g | 47% | 0.23 |
| | DF-12 surfactant⁴ | | |
| 10b | 5.25 g 50% NaOH, 2.63 g 45% KOH and 0.1 g | 52% | 0.27 |
| | DF-12 surfactant⁴ | | |
| 11a | 7.9 g 50% NaOH and 0.1 g DF-12 surfactant⁴ | 43% | 0.21 |
| 11b | 7.9 g 50% NaOH and 0.1 g DF-12 surfactant⁴ | 43% | 0.21 |

¹Nonylphenol ethoxylate having 9 moles of EO non-ionic surfactant available as TERGITOL ™ NP-9 from The Dow Chemical Company.
²Copolymer of acrylic acid and 2-acrylamido-2-methylpropane sulfonic acid added as 40% by weight solution in water available as NC-233 from The National Colloid Company.
³Amphoteric surfactant available from Evonik.
⁴Modified polyethoxylated alcohol non-ionic surfactant available as TRITON ™ DF-12 from The Dow Chemical Company.

The treatment that had the highest percentage of deposit dissolved was Treatment 2, which was 50% NaOH with NP-9 surfactant. The next best treatment was Treatment 4, which is Treatment 2 plus AA/AMPS copolymer. However, comparing Treatment 4 with Treatments 2 and 3, it appears that combining NP-9 and AA/AMPS copolymer hinders performance compared to NP-9 alone with 50% NaOH or AA/AMPS copolymer alone with 50% NaOH. Treatment 6, which was a 50:50 by mass blend of 50% NaOH and 45% KOH, performed almost as well as Treatment 2 when comparing percent of deposit dissolved. If the ratio of the mass of deposit dissolved to the mass of active ingredients in the treatment is evaluated, Treatment 6 performed the best, slightly better than Treatment 2, and followed by Treatments 5 and 10.

Other treatments showed that some surfactants hindered performance (e.g. Tomamine® Alkali Surfactant in Treatments 7 and 9). Dow DF-12 improved the performance of the NaOH/KOH blend (Treatment 8 vs 10), but slightly reduced the efficacy of NaOH alone, as seen when Treatment 1 is compared with Treatment 11. NP-9 surfactant provided the greatest improvement in performance to 50% NaOH (Treatment 1 vs. 2).

### Example 2

Evaluation of EDTA Additive: Similar to the previous examples, the elemental sulfur containing deposit was obtained from a landfill in Florida. These treatments were conducted with and without landfill leachate being added to the samples. Each sample had about 2 grams of the sulfur-containing deposit. Some samples had a 39% solution of the tetrasodium salt of EDTA (ethylenediaminetetraacetic acid) added in addition to the alkaline material (sodium hydroxide). Following addition of the treatments, the samples were allowed to rest at room temperature for 24 hours. After 24 hours had elapsed, the solids remaining in each sample were collected by filtration, dried and their final mass determined. The results were mixed when EDTA was added. In sample 2 below, there was a slight improvement dissolving the deposit when EDTA was present. In sample 4, there was no impact of EDTA on the dissolution of the deposit. In sample 6, EDTA had a negative impact on the mass of deposit dissolved.

TABLE 2

| | | | | | Mass of deposit |
|---|---|---|---|---|---|
| | | | | Percent | dissolved/mass |
| | Treatment | Leachate | | deposit | active ingredient |
| Sample | Description | added | | dissolved | in treatment |
| 1 | 5 g of 20% NaOH | 10 | g | 18% | 0.36 |
| 2 | 5 g of 20% NaOH | 10 | g | 25% | 0.50 |
| | with 2 g of 39% | | | | |
| | Na₄EDTA | | | | |
| 3 | 8 g of 50% NaOH | 0 | g | 43% | 0.22 |
| 4 | 8 g of 50% NaOH | 0 | g | 43% | 0.23 |
| | with 4 g of 39% | | | | |
| | Na₄EDTA | | | | |
| 5 | 8 g of 50% NaOH | 10 | g | 58% | 0.29 |
| 6 | 8 g of 50% NaOH | 10 | g | 30% | 0.15 |
| | with 4 g of 39% | | | | |
| | Na₄EDTA | | | | |

### Example 3

Evaluation of Sodium Sulfite: The impact of sodium sulfite on dissolution of the sulfur-containing deposit was also tested. These samples all had about 2 grams of sulfur-containing deposit and 10 grams of landfill leachate. Sodium sulfite (dry, powder) was added to samples 2 and 3, while the mass of 50% NaOH was held constant. As the mass of sodium sulfite added increased, the mass of deposit dissolved decreased. No further testing was conducted with sodium sulfite.

TABLE 3

| | | | | Mass of deposit |
|---|---|---|---|---|
| | | | Percent | dissolved/mass |
| | Treatment | Leachate | deposit | active ingredient |
| Sample | Description | added | dissolved | in treatment |
| 1 | 8 g of 50% NaOH | 10 g | 43% | 0.21 |
| 2 | 8 g of 50% NaOH | 10 g | 22% | 0.11 |
| | with 1 g sodium | | | |
| | sulfite | | | |
| 3 | 8 g of 50% NaOH | 10 g | 16% | 0.08 |
| | with 2 g sodium | | | |
| | sulfite | | | |

### Example 4

Evaluation of AA/AMPS Dispersant: The impact of AA/AMPS copolymer on total suspended solids (TSS) formation in treated leachate was determined. The AA/AMPS copolymer is a 44% active solution. The addition of sodium hydroxide (50% NaOH was used) to landfill leachate has the potential to precipitate metals and calcium carbonate from the leachate, resulting in increased suspended solids. These solids could negatively affect landfill operations.

Each sample started with 10 grams of landfill leachate. No deposit was present or added to these samples. Varying amounts of 50% NaOH were added to the samples. As the mass of 50% NaOH increased, the TSS also increased. One sample received 1 gram of AA/AMPS copolymer in addition to 50% NaOH. The TSS in the sample with AA/AMPS copolymer had ˜13% less TSS than the sample with equal 50% NaOH without AA/AMPS copolymer. It appears that AA/AMPS dispersant could be helpful in reducing TSS formation that may cause operational issues associated with TSS formation during treatment.

TABLE 4

| | | Total suspended |
|---|---|---|
| Sample | Treatment description | solids |
| 1 | 4 g of 50% NaOH | 165 mg/L |
| 2 | 8 g of 50% NaOH | 278 mg/L |
| 3 | 12 g of 50% NaOH | 348 mg/L |
| 4 | 8 g of 50% NaOH with | 243 mg/L |
| | 1 g AA/AMPS copolymer | |
| | solution¹ | |

¹Copolymer of acrylic acid and 2-acrylamido-2-methylpropane sulfonic acid added as 40% by weight solution in water available as NC-233 from The National Colloid Company.

### Example 5

Evaluation of dispersants: An elemental sulfur containing deposit was obtained from a landfill in Florida. Samples of the deposit were placed in landfill leachate. Various treatments were added to the leachate and deposit to determine the efficacy of each treatment to dissolve the deposit. Each sample had about 2 grams of the sulfur containing deposit, 10 grams of landfill leachate, 0.1 gram of dispersant product (varying active content, about 40-50% by weight) and 8 grams of alkaline material (5.37 grams of 50% NaOH and 2.63 grams of 45% KOH). Following addition of the treatments, the samples were allowed to rest at room temperature for 24 hours. After 24 hours had elapsed, the solids remaining in each sample were collected by filtration, dried and their final mass determined. A summary of the results is shown in the table below.

As seen in the table below, the greatest improvement was with Acumer 3100 followed by Versaflex ONE. Acumer 1000 and Acumer 5000 performed similarly to one another. NC-233 and XF-321 inhibited the dissolution of the sulfur containing deposit slightly relative to the control sample with no dispersant.

TABLE 5

| Dispersant | Solids | | |
|---|---|---|---|
| Product | dissolved | Improvement | |
| Name | (%) | over control | Chemistry |
| None | 62% | — | — |
| Acumer ™ 1000¹ | 67% | 8.6% | Acrylic acid |
| | | | homopolymer |
| Acumer ™ 3100² | 73% | 18.4% | Carboxylate/Sulfonate/ |
| | | | Nonionic functional |
| | | | terpolymer |
| Acumer ™ 5000³ | 67% | 9.0% | Proprietary |
| | | | multifunctional |
| | | | polymer |
| NC-233⁴ | 61% | −1.6% | AA/AMPS copolymer |
| Versaflex ® ONE⁵ | 69% | 11.3% | Sulfonated acrylic-acid |
| | | | based copolymer |
| XF-321W⁶ | 61% | −0.9% | Polymaleic acid |

¹Available from The Dow Chemical Company.
²Available from The Dow Chemical Company.
³Available from The Dow Chemical Company.
⁴Copolymer of acrylic acid and 2-acrylamido-2-methylpropane sulfonic acid added as 40% by weight solution in water available as NC-233 from The National Colloid Company.
⁵Available from Nouryon.
⁶Available from Uniphos Chemical.

### Example 6

Evaluation of surfactants: An elemental sulfur containing deposit was obtained from a landfill in Florida. Samples of the deposit were placed in landfill leachate. Various treatments were added to the leachate and deposit to determine the efficacy of each treatment to dissolve the deposit. Each sample had about 2 grams of the sulfur containing deposit, 10 grams of landfill leachate, 0.1 gram of surfactant product (all 100% active) and 8 grams of alkaline material (5.37 grams of 50% NaOH and 2.63 grams of 45% KOH). Following addition of the treatments, the samples were allowed to rest at room temperature for 24 hours. After 24 hours had elapsed, the solids remaining in each sample were collected by filtration, dried and their final mass determined. A summary of the results is shown in the table below.

As seen in the table below, NP-9 provided the greatest increase in the mass dissolved of the sulfur containing deposit. NP-11, TOMADOL 1-3, and TOMADOL 1-7 all had similar increases over the control sample while NP-4 provided a slight increase relative to the control. Surfactants are often compared based on their HLB (hydrophilic-lipophilic balance), which is listed in the table as well. HLB alone does not appear to be a determining factor in performance in this testing as, for example, NP-4 and TOMADOL 1-3 have similar HLB's but different results in the scale dissolving tests.

TABLE 6

| | Average | | | |
|---|---|---|---|---|
| | solids | Improvement | | |
| Surfactant | dissolved (%) | over control | HLB | Chemistry |
| none | 51.5% | — | — | — |
| NP-4¹ | 53.5% | 4.0% | 8.9 | nonylphenol |
| | | | | ethoxylate, |
| | | | | 4 moles EO |
| NP-9² | 66.8% | 29.8% | 12.9 | nonylphenol |
| | | | | ethoxylate, |
| | | | | 9 moles EO |
| NP-11³ | 62.1% | 20.6% | 13.5 | nonylphenol |
| | | | | ethoxylate, |
| | | | | 11 moles EO |
| TOMADOL ® 1-3⁴ | 61.1% | 18.7% | 8.7 | C11 |
| | | | | ethoxylated |
| | | | | alcohol, |
| | | | | 3 moles EO |
| TOMADOL ® 1-7⁵ | 61.9% | 20.3% | 12.9 | C11 |
| | | | | ethoxylated |
| | | | | alcohol, |
| | | | | 7 moles EO |

¹Nonylphenol ethoxylate having 4 moles of EO non-ionic surfactant available as TERGITOL ™ NP-4 from The Dow Chemical Company.
²Nonylphenol ethoxylate having 9 moles of EO non-ionic surfactant available as TERGITOL ™ NP-9 from The Dow Chemical Company.
³Nonylphenol ethoxylate having 11 moles of EO non-ionic surfactant available as TERGITOL ™ NP-11 from The Dow Chemical Company.
⁴Ethoxylated alcohol available from Evonik.
⁵Ethoxylated alcohol available from Evonik.

### Example 7

Evaluation of surfactants: An elemental sulfur containing deposit was obtained from a landfill in Florida. Samples of the deposit were placed in landfill leachate. Various treatments were added to the leachate and deposit to determine the efficacy of each treatment to dissolve the deposit. Each sample had about 2 grams of the sulfur containing deposit, 10 grams of landfill leachate, 0.1 gram of surfactant product (all 100% active) and 8 grams of alkaline material (5.37 grams of 50% NaOH and 2.63 grams of 45% KOH). Following addition of the treatments, the samples were allowed to rest at room temperature for 24 hours. After 24 hours had elapsed, the solids remaining in each sample were collected by filtration, dried and their final mass determined. A summary of the results is shown in the table below.

These results are similar to the previous example. NP-9 again provided the best results. NP-4 was greatly improved compared to the previous examples. Overall, the nonylphenol ethoxylates performed better than the ethoxylated alcohols. Here it also appears that HLB alone is not a determining factor.

TABLE 7

| | Average | | | |
|---|---|---|---|---|
| | solids | Improvement | | |
| Surfactant | dissolved (%) | over control | HLB | Chemistry |
| none | 58.7% | — | — | — |
| NP-4¹ | 70.6% | 20.3% | 8.9 | nonylphenol |
| | | | | ethoxylate, |
| | | | | 4 moles EO |
| NP-9² | 72.4% | 23.4% | 12.9 | nonylphenol |
| | | | | ethoxylate, |
| | | | | 9 moles EO |
| NP-11³ | 72.2% | 23.0% | 13.5 | nonylphenol |
| | | | | ethoxylate, |
| | | | | 11 moles EO |
| TOMADOL ® 1-3⁴ | 67.6% | 15.1% | 8.7 | C11 |
| | | | | ethoxylated |
| | | | | alcohol, |
| | | | | 3 moles EO |
| TOMADOL ® 1-5⁵ | 67.3% | 14.6% | 11.2 | C11 |
| | | | | ethoxylated |
| | | | | alcohol, |
| | | | | 5 moles EO |
| TOMADOL ® 1-7⁶ | 66.0% | 12.5% | 12.9 | C11 |
| | | | | ethoxylated |
| | | | | alcohol, |
| | | | | 7 moles EO |

¹Nonylphenol ethoxylate having 4 moles of EO non-ionic surfactant available as TERGITOL ™ NP-4 from The Dow Chemical Company.
²Nonylphenol ethoxylate having 9 moles of EO non-ionic surfactant available as TERGITOL ™ NP-9 from The Dow Chemical Company.
³Nonylphenol ethoxylate having 11 moles of EO non-ionic surfactant available as TERGITOL ™ NP-11 from The Dow Chemical Company.
⁴Ethoxylated alcohol available from Evonik.
⁵Ethoxylated alcohol available from Evonik.
⁶Ethoxylated alcohol available from Evonik.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, unless indicated otherwise, a plural term can encompass its singular counterpart and vice versa, unless indicated otherwise. For example, although reference is made herein to “a” treatment composition, “an” alkaline material, “a” surfactant, and “a” dispersant, a combination (i.e., a plurality) of these components can be used.

In addition, in this application, the use of “or” means “and/or” unless specifically stated otherwise, even though “and/or” may be explicitly used in certain circumstances.

As used herein, “including,” “containing” and like terms are understood in the context of this application to be synonymous with “comprising” and are therefore open-ended and do not exclude the presence of additional undescribed or unrecited elements, materials, ingredients or method steps. Nevertheless, they also include the more restrictive terms “consisting of” and “consisting essentially of”. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

What is claimed is:

1. A method of removing a sulfur-containing deposit from landfill infrastructure comprising:
(a) forming a treatment composition comprising an alkaline material; and
(b) contacting the sulfur-containing deposit within the landfill infrastructure with a treatment composition comprising an alkaline material, whereby the sulfur-containing deposit is at least partially dissolved.

2. The method of claim 1, wherein the sulfur-containing deposit comprises elemental sulfur.

3. The method of claim 1, wherein the alkaline material comprises sodium hydroxide, potassium hydroxide, calcium hydroxide, magnesium hydroxide, ammonium hydroxide, lime, or any combination thereof.

4. The method of claim 1, wherein the treatment composition further comprises a surfactant.

5. The method of claim 4, wherein the surfactant comprises a non-ionic surfactant.

6. The method of claim 5, wherein the non-ionic surfactant comprises a nonylphenol ethoxylate.

7. The method of claim 1, wherein the treatment composition further comprises a dispersant.

8. The method of claim 7, wherein the dispersant comprises a copolymer of acrylic acid and 2-acrylamido-2-methylpropane sulfonic acid.

9. The method of claim 1, wherein the treatment composition is substantially free of ethylenediaminetetraacetic acid, nitrilotriacetic acid, diethylene-triamine pentaacetic acid, sodium sulfite, sodium bisulfite, potassium sulfite, potassium bisulfite, and/or hydroxyethylethylenediaminetriacetic acid.

10. The method of claim 1, wherein the at least partial dissolution of the sulfur-containing deposit forms a modified treatment composition, and the method further comprises removing the modified treatment composition.

11. The method of claim 1, wherein forming the treatment composition comprises adding a composition comprising the alkaline material and optionally a surfactant and/or a dispersant to a landfill leachate in fluid communication with the sulfur-containing deposit.

12. The method of claim 1, wherein the landfill infrastructure comprises a landfill leachate collection system and/or a landfill gas collection system.

13. The method of claim 1, wherein the sulfur-containing deposit resides on or within a landfill gas extraction pipe, a landfill leachate pipe, a sump in fluid communication with the landfill gas extraction pipe or the landfill leachate pipe, a pump, a screen, a grit chamber, a force main, gravel packing, and/or waste material.

14. The method of claim 1, wherein the sulfur-containing deposit resides within an interior of a pipe that extends beneath a surface of a landfill, and the method further comprises introducing the treatment composition into the interior of the pipe, wherein the treatment composition contacts the sulfur-containing deposit within the interior of the pipe.

15. The method of claim 14, wherein the pipe is a landfill gas extraction pipe comprising a wellhead that resides above the surface of the landfill and the method further comprises introducing the treatment composition through the wellhead and into the interior of the landfill gas extraction pipe.

16. The method of claim 14, wherein the pipe is a landfill gas extraction pipe having a lower end that is in fluid communication with a sump that resides beneath the surface of the landfill, and the sulfur-containing deposit also resides within the sump, and the method further comprises introducing the treatment composition into the sump, wherein the treatment composition contacts the sulfur-containing deposit within the sump.

17. The method of claim 14, wherein the at least partial dissolution of the sulfur-containing deposit forms a modified treatment composition, and the method further comprises:
removing the modified treatment composition from the interior of the pipe, and
reintroducing into the interior of the pipe at least a portion of the removed modified treatment composition and optionally introducing an additional amount of the treatment composition.

18. The method of claim 1, wherein contacting the sulfur-containing deposit within the landfill infrastructure with the treatment composition is conducted with an application method comprising at least one of spray application of the treatment composition, static immersion application of the treatment composition, or flow application of the treatment composition.

19. The method of claim 1, wherein contacting the sulfur-containing deposit within the landfill infrastructure with the treatment composition is conducted under the application of pressure.

20. The method of claim 1, wherein contacting the sulfur-containing deposit within the landfill infrastructure with the treatment composition is conducted at a temperature of from ambient temperature to 99° C.

21. The method of claim 1, wherein the treatment composition is contacted with the sulfur-containing deposit for a residence period of at least 1 hour.

22. The method of claim 1, wherein the treatment composition has a pH of at least 9.
